(19) United States
(12) Patent Application Publication
(10) Pub. No.: US 2012/0054682 A1
(43) Pub. Date: Mar. 1, 2012

(54) SYSTEM AND METHOD FOR GRAPHICAL CONTEXT DRILL-DOWN

(75) Inventors: Denise A. Bell, Austin, TX (US); Clark L. Gussin, San Jose, CA (US); Polyxeni Mountrouidou, Williamsburg, VA (US)

(73) Assignee: INTERNATIONAL BUSINESS MACHINES CORPORATION, Armonk, NY (US)

(21) Appl. No.: 12/862,022

(22) Filed: Aug. 24, 2010

(51) Int. Cl. G06F 3/048

(52) U.S. Cl. 715/817

(57) ABSTRACT

A system to display a graphical view for event drill-down. The system includes an environment monitor and a remote device. The environment monitor monitors an environment for an event. The environment monitor generates and sends a notification in response to detection of the event within the environment. The remote device receives the notification. The remote device is remote relative to at least one resource corresponding to the event. The remote device includes a data storage device, a display device, a user interface input device, and a processor. The data storage device stores data. The display device is coupled to the data storage device. The display device displays a notification related to an event. The user interface input device facilitates a user input to generate a context menu corresponding to the notification. The context menu includes at least one user interaction option corresponding to the event. The processor is coupled to the user interface input device and the display. The processor generates a graphical view on the display of at least one relationship between the event and at least one resource corresponding to the event. The graphical view is available within the context menu.

### BACKGROUND

Data display interfaces are used to display data to a user so that the user can view and analyze the data. One example of a data display interface is an IT management user interface tool that displays content such as IT resources and events. Conventional data display interfaces offer a variety of different user interfaces to view IT resources and events. Some interfaces allow actions to be taken by the user for specific resources or events through menus, lists, hot-keys, etc. The available actions are configured for specific resources or events. For example, some conventional data display interfaces provide context menus to create groups such as clusters and to load balance requests between resources. Other data display interfaces provide cluster resources to facilitate cluster hierarchical organization. Some data display interfaces provide diagnostics prior to the formation of the cluster to analyze potential problem areas through simulation. However, conventional data display interfaces do not let the user see relationships or take actions on related resources.

Additionally, conventional data display interfaces are cumbersome and resource-intensive. Frequently, full system analysis involves execution of multiple heavy programs. This restricts use of conventional data display interfaces to devices with sufficient computational resources to run the intensive analysis programming.

### SUMMARY

Embodiments of a system are described. In one embodiment, the system is a system to display a graphical view for event drill-down. An embodiment of the system includes an environment monitor and a remote device. The environment monitor monitors an environment for an event. The environment monitor generates and sends a notification in response to detection of the event within the environment. The remote device receives the notification. The remote device is remote relative to at least one resource corresponding to the event. The remote device includes a data storage device, a display device, a user interface input device, and a processor. The data storage device stores data. The display device is coupled to the data storage device. The display device displays a notification related to an event. The user interface input device facilitates a user input to generate a context menu corresponding to the notification. The context menu includes at least one user interaction option corresponding to the event. The processor is coupled to the user interface input device and the display. The processor generates a graphical view on the display of at least one relationship between the event and at least one resource corresponding to the event. The graphical view is available within the context menu. Other embodiments of the system are also described. Embodiments of methods and computer program products with the same or similar functionality are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of a system for resource management.

FIG. 2 depicts a schematic diagram of one embodiment of a user device for remote resource management.

FIG. 3 depicts a graphical diagram of one embodiment of an event in an environment.

FIG. 4 depicts a schematic diagram of one embodiment of a context menu with a graphical view and corresponding user-selectable response menu.

FIG. 5 depicts a schematic diagram of one embodiment of an event response drill-down process.

FIG. 6 depicts a schematic diagram of another embodiment of an expanded graphical view with a user-selected event response.

FIG. 7 depicts a schematic diagram of one embodiment of a method for implementing a context menu with a graphical view.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments apply a context menu and graphical view for resource management. In some embodiments, a notification of an event is perceived by a user and a context menu related to the event provides a graphical view of the event and corresponding resources. This type of functionality allows a user to respond to the event based on the relationships provided by the graphical view without executing external programs.

Some embodiments described herein are applicable to system resource management. In some embodiments, the system resource is managed remotely through a mobile or separate device. Examples of such mobile or separate devices include cell phones, PDAs, hand-held monitoring devices, and so forth. However, other embodiments may be used with other types of mobile devices. Examples of systems that may be monitored include servers, databases, networks, etc. However, other embodiments may be used with other types of systems or resources.

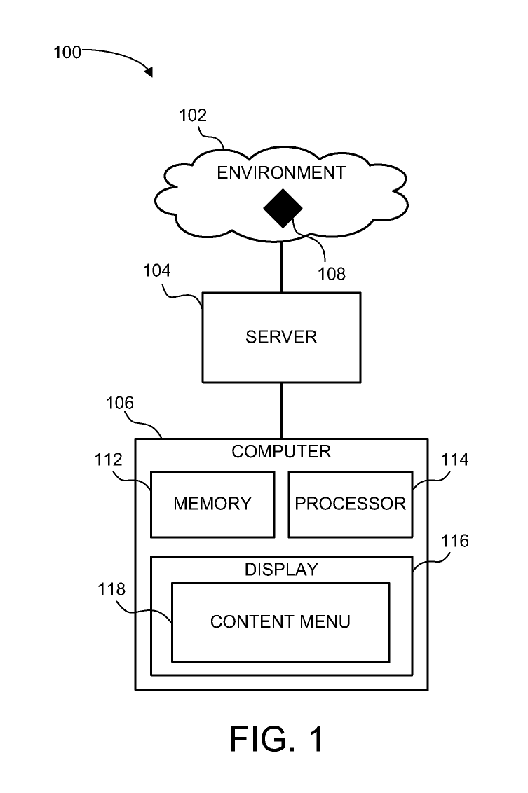

FIG. 1 depicts a schematic block diagram of one embodiment of a system 100 for resource management. The illustrated system 100 includes an environment 102, a server 104, and a computer 106. The environment 102 is coupled to the server 104. The environment 102 may be a single resource or a group of resources. For example, the environment 102 may include one or more servers or a cluster. The environment 102 may include one or more devices in a network or independently arranged. The environment 102 may include one or more storage resources, processing resources, or other computer or data resources. The environment 102 includes an event 108 at one or more of the resources within the environment 102. The event 108 is described in greater detail below.

The environment 102 is coupled to a server 104. In some embodiments, the server 104 includes a monitor 110. The monitor 110 monitors the environment 102 for various events and/or variables. Additionally, in one embodiment, the monitor 110 stores data related to the environment 102 on the server 104. In another embodiment, the server 104 includes other electronic resources. For example, the server 104 may include one or more processors, nodes, clusters, networks, clients, databases, memory, power sources, or other electronic resources to monitor the environment 102. In some embodiments, the server 104 controls some portion of the environment 102. For example, the server 104 may control process routing within the environment 102. The server 104 may control load balancing within the environment 102. In another embodiment, the server 104 may control memory allocation within the environment 102. The server 104 may also control processing, for example, parallel processing, within the environment 102. The server 104 is coupled to the computer 106. In some embodiments, the monitor 110 on the server 104 includes resources and programs to monitor the environment 102 and generate analysis of the performance of the environment 102. In some embodiments, the monitor 110 generates graphical analysis of the event 108 detected in the environment 102 by the monitor 110. The monitor may perform additional tasks related to the environment 102.

The computer 106 includes a memory 112, a processor 114, and a display 116. The display 116 includes a context menu 118. In particular, the computer 106 is coupled to the server 104 to receive data from the server 104. In some embodiments, the computer 106 receives notification from the server 104 regarding the environment 102. In some embodiments, the computer 106 requests data from the server 104 regarding the status of the environment 102. In other words, the computer 106 monitors the environment 102 via the server 104.

The memory 112 of the computer 106 stores data. In some embodiments, the memory 112 includes disks or other non-disk type memory. In other embodiments, the memory 112 is a random access memory (RAM) or another type of dynamic storage device. In other embodiments, the memory 112 is a read-only memory (ROM) or another type of static storage device. In other embodiments, the illustrated memory 112 is representative of both RAM and static storage memory within the computer 106. Hence, the memory 112 may store operations and functions associated with the processor 114 and/or the display 116. In other embodiments, the memory 112 is an electronically programmable read-only memory (EPROM) or another type of storage device. Other embodiments of the system 100 may implement other types of data memory devices which store some or all of the memory 112. For example, in some embodiments, at least a portion of the memory 112 may be stored in a cache (not shown) that is separate from or integrated with the processor 114.

In some embodiments, the computer 106 may obtain data from another memory 112 that is located remotely from the computer 106. For example, data may be obtained from a data stream over a network such as the Internet, the server 104, or the environment 102. In some embodiments, the memory 112 stores program or process code that is executed by the processor 114 to generate a context menu 118 to a user on the display 116.

The display 116 includes one or more display monitors such as a liquid crystal display (LCD) and/or a cathode ray tube (CRT) display. The display 116 may be modular so that it is separate from, but electronically connects to the processor 114 and other components of the system 100. Alternatively, the display 116 may be integrated into the system 100, for example, in the form of a handheld computing device such as a personal digital assistant (PDA) or a mobile telephone. In one embodiment, the display 116 is configured to visually communicate a content menu 118 based on an event 108 in the environment 102 detected via the server 104.

The context menu 118 can be displayed by a variety of representations depending on the type of visual representation and formatting that is selected or implemented by a specific application executed by the computer 106. Specifically, the context menu 118 may be displayed as a list, a folder, a directory, or other format. In some embodiments, the context menu 118 is generated in response to a user input. In another embodiment, the context menu 118 is generated by the computer 106 in response to detection of the event 108. Other embodiments generate the context menu 118 based on other criteria.

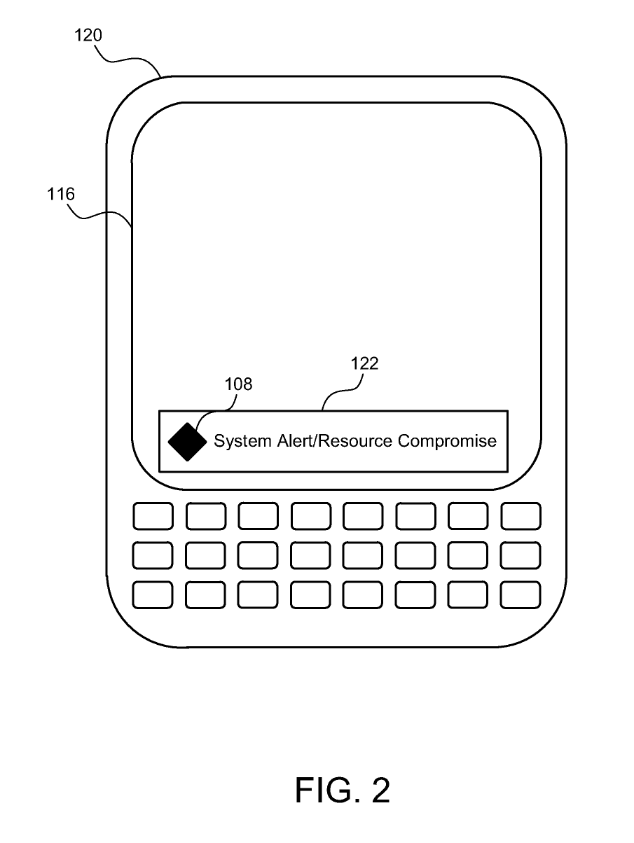

FIG. 2 depicts a schematic diagram of one embodiment of user device 120 for remote resource management. In the illustrate embodiment, the user device 120 is a personal device. In other embodiments, the user device 120 may be a desktop or laptop computer, a workstation, a stationary or mobile surveillance device, or other mobile or stationary electronic computing devices. In the illustrated embodiment, the user device 120 includes a display 116 showing an alert 122 corresponding to an event 108. In some embodiments, the alert 122 is graphically displayed to the user upon detection of the event 108. In other embodiments, the alert 122 is communicated to the user through non-graphical communication. For example, the user device 120 may generate a sound and/or vibration related to the event 108. Upon detection of the sound and/or vibration, or in response to the alert 122, the user may execute a program to provide further information corresponding to the event 108. In other embodiments, the user device 120 displays a context menu 118 upon detection of the event 108. In other embodiments, the user device 120 notifies a user of the event 108 in other ways. For example, the user device 120 might provide notification of the event 108 through lights, tones, etc.

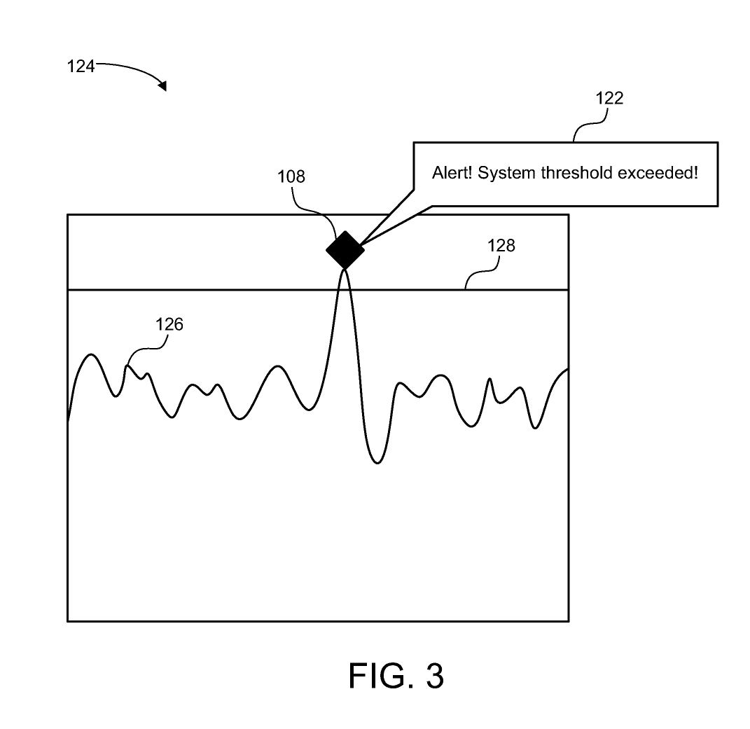

FIG. 3 depicts a graphical diagram 124 of one embodiment of an event 108 in an environment 102. In the illustrate embodiment, a parameter 126 of the environment 102 is plotted with respect to a threshold 128. In response to the parameter 126 exceeding the threshold 128, an alert 122 is generated. In the illustrated embodiment, the event 108 constitutes the parameter 126 exceeding the threshold 128. In other embodiments, the event 108 constitutes other detected qualities. The event 108 triggers the generation of an alert 122. In some embodiments, the alert 122 is sent to a user device 120 (See FIG. 2). In some embodiments, the parameter 126 is an operating parameter of a system within the environment 102. In other embodiments, the parameter 126 is another metric of a component or group of components within the system 100.

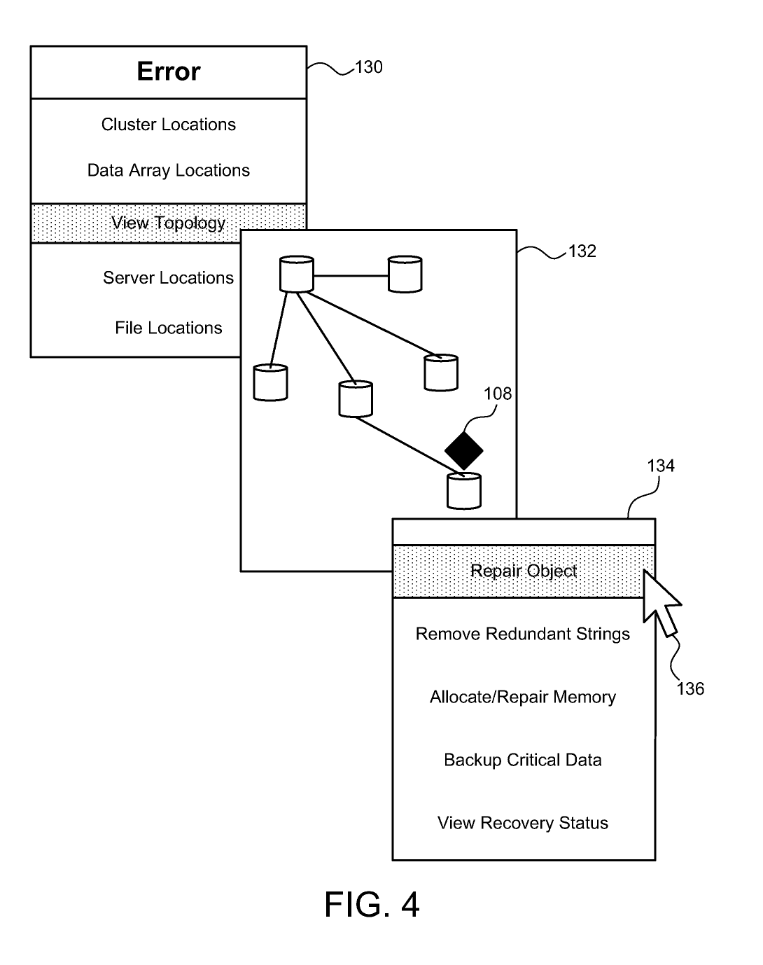

FIG. 4 depicts a schematic diagram of one embodiment of a context menu 130 with a graphical view 132 and corresponding user-selectable response menu 134. In the illustrated embodiment, the context menu 130 is generated in response to an alert 122. In some embodiments, the context menu 130 is generated with only options corresponding to the alert 122. In other embodiments, the context menu 130 includes a standard list of options. Additionally, in another embodiment, the context menu 130 includes a standard list of options with only the options that are applicable to the event 108 active or selectable. In general, the context menu 130 includes an option to display a graphical view 132.

In the illustrated embodiment, the graphical view 132 is a graphical representation of relationships corresponding to the event 108. In some embodiments, the graphical view 132 shows systems related to the event 108 by program, protocol, or other electronic, physical, or communicative relationship. The graphical view 132 allows a user to view the location of the event 108 and the related systems in a relatively simple and intuitive manner. This allows the user to address the event 108 and respond in an informed manner without having to execute an external or resource intensive program. The user is provided with response options via the user-selectable response menu 134.

In the illustrated embodiment, the user-selectable response menu 134 provides the user with a menu of options corresponding to the event 108. In some embodiments, the user-selectable response menu 134 includes a standard set of options with the options that are applicable to the event 108 active or highlighted while the non-applicable options may be inactive, faded, or grayed out. In other embodiments, the user-selectable response menu 134 may query the user to input a command or string describing what he/she would like to do in response to the event 108. In some embodiments, the user may respond to the event 108 by repairing the affected resource, redirecting a signal or process, or redistributing a resource or load by selecting an option with a cursor 136. In other embodiments, the user-selectable response menu 134 may respond to voice, touch, or other user inputs. Additionally, the user may request additional information relative to the event 108 via the user-selectable response menu 134.

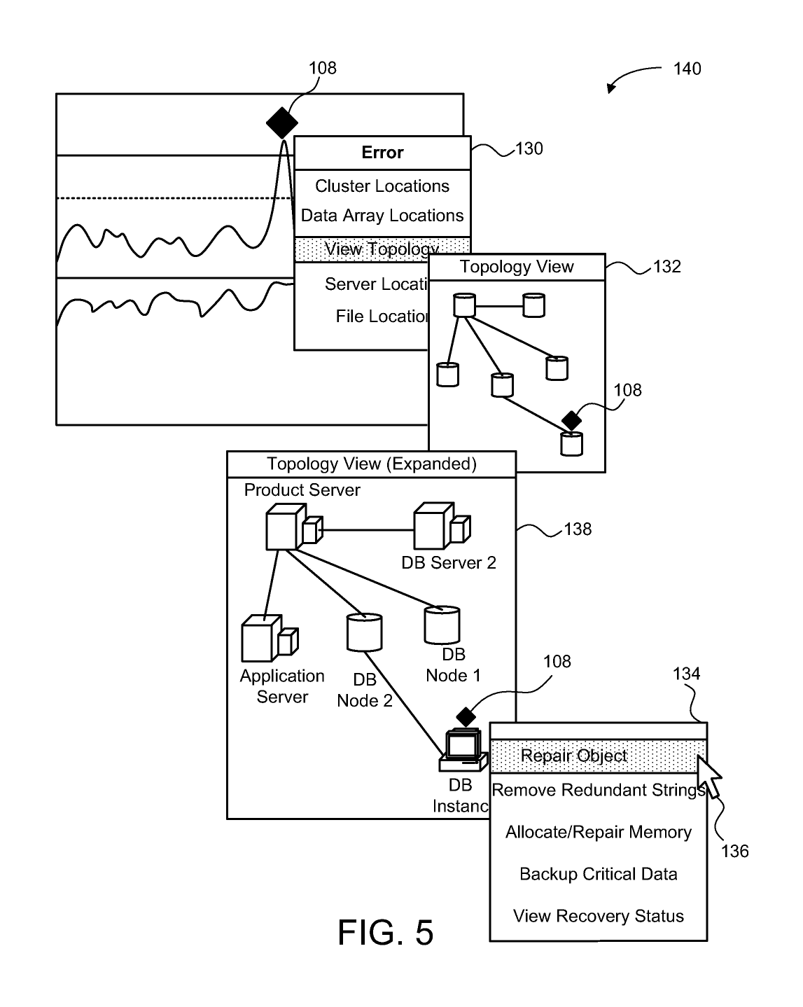

FIG. 5 depicts a schematic diagram of one embodiment of an event response drill-down process 140. In the illustrated embodiment, the event response drill-down 140 shows a series of menus and views that may be available to a user in response to an event 108. Although the menus and views are shown and described in a certain order, it should be noted that the menus and views may be rearranged or reorganized in a different order. In the illustrated embodiment, an event 108 was detected at an environment 102. In response to detection of the event 108, a context menu 130 is generated. The user selected to view a graphical view 132 of a topology corresponding to the event 108. The graphical view 132 illustrates the general location of the event 108 and relationships corresponding to the event 108. In some embodiments, the graphical view 132 is a chart. Other embodiments include other types of graphical representations in the graphical view 132. Although certain resources such as nodes, servers, and instances are shown in a specific arrangement with specific relationships and labels, other embodiments may include any number or configuration of resources, electronic or otherwise.

In the illustrated embodiment, the user expanded the graphical view 132 to an expanded graphical view 138. In one embodiment, the expanded graphical view 138 includes additional detail about the relationships corresponding to the event 108. In particular, the expanded graphical view 138 may include names, locations, resources, availability, load, signal strength, or other parameters or information that may be useful to a user in addressing the event 108. In the illustrated embodiment, it is shown in the expanded graphical view 138 that the event 108 corresponds to a DB Instance. The location of the event 108 is related to the DB Node 2 connected to the DB Instance. In some embodiments, providing this relationship to the user may facilitate a more effective or efficient response to the event 108.

In the illustrated embodiment, a user-selectable response menu 134 was generated relative to the event 108 at the DB Instance. The user-selectable response menu 134 displays options available as responses to the event 108. In the illustrated embodiment, the user has highlighted the Repair Object response in the user-selectable response menu 134 with the cursor 136. In some embodiments, the user can assign a response to a user input. For example, the user may assign a double left-click at the event 108 to cause a Repair to occur. Alternatively, the user may assign a keystroke or hot-key to select a certain response. Other inputs can be assigned to generate other responses.

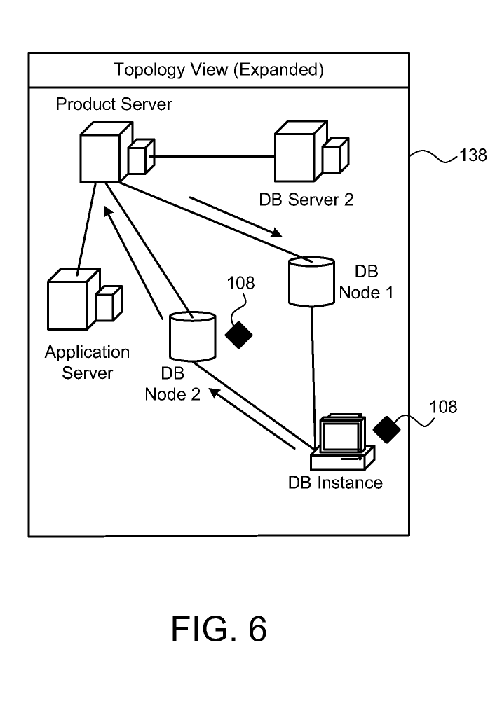

FIG. 6 depicts a schematic diagram of another embodiment of an expanded graphical view 138 with a user-selected event response. In the depicted embodiment of the expanded graphical view 138, the user has discovered that the event 108 that was detected at the DB Instance is caused at the DB Node 2. The user responds to the event 108 at DB Node 2 that was affecting the DB Instance by redirecting the task of the Product Server through DB Node 1. The drill-down analysis by the user is facilitated by the expanded graphical view 138 with the displayed relationships accessed through the context menu 130.

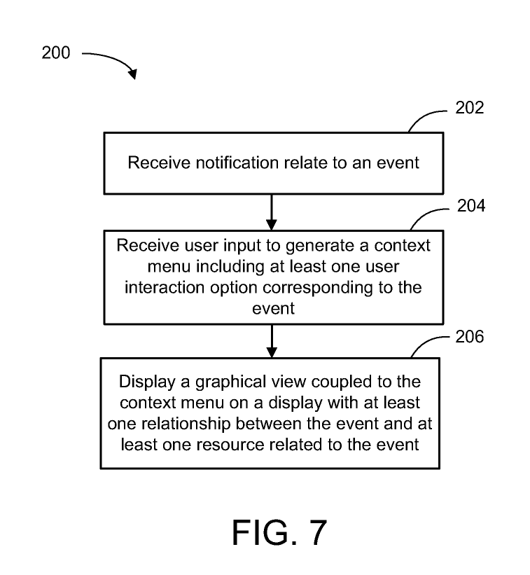

FIG. 7 depicts a schematic diagram of one embodiment of a method 200 for implementing a context menu with a graphical view 132. At box 202, notification is received related to an event 108. At box 204, user input is received to generate a context menu 130 including at least one user interaction option corresponding to the event 108. At box 206, a graphical view 132, which is coupled to the context menu 130, is displayed on a display 116 with at least one relationship between the event 108 and at least one resource related to the event 108. The depicted method 200 then ends. Other embodiments of the method 200 may include further operation related to the functionality described herein.

Embodiments described herein can be used in various ways to provide a graphical view of an event in an environment. In some embodiments, the graphical techniques described herein can be applied to remote systems in which systems can be remotely controlled in response to an event. In some embodiments, the graphical technique described herein can be applied as an on-site monitor for a local system. Thus, embodiments described herein provide an event notification and drill-down system.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

An embodiment of a drill-down system includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer usable storage medium for execution by a computer. As an example, an embodiment of a computer program product includes a computer useable storage medium to store a computer readable program that, when executed on a computer, causes the computer to perform operations for interactive filtering. Examples of some of the potential operations are explained above with respect to the system 100 and the method 200.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-usable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the drill down system to become coupled to other data processing systems or remote environments or servers through intervening private or public networks. Modems, cable modems, and Ethernet cards are just a few of the currently available types of network adapters.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product comprising a computer usable storage medium to store a computer readable program for an event drill-down, wherein the computer readable program, when executed on a computer, causes the computer to perform operations comprising:
receiving a notification related to an event on a remote device, wherein the notification is generated at an environment monitor and the event corresponds to a performance of a resource of an environment, wherein the remote device is remote relative to the resource in the environment;
generating a context menu related to the resource, wherein the context menu comprises at least one user interaction option corresponding to the event; and
displaying a graphical view of at least one relationship between the event and the resource related to the event, wherein the graphical view is available via the context menu on a display.

2. The computer program product of claim 1, wherein the computer readable program, when executed on a computer, causes the computer to display the graphical view in response to a user interaction at the context menu.

3. The computer program product of claim 1, wherein the computer readable program, when executed on the computer, causes the computer to display the context menu in response to a user interaction corresponding to the notification.

4. The computer program product of claim 1, wherein the computer readable program, when executed on the computer, causes the computer to perform further operations comprising executing a user-selected action as a response to the event.

5. The computer program product of claim 1, wherein the computer readable program, when executed on the computer, causes the computer to display the graphical view in an absence of executing an external program to generate the graphical view and the at least one relationship.

6. The computer program product of claim 1, wherein the computer readable program, when executed on the computer, causes the computer to display the graphical view as a topographical view.

7. The computer program product of claim 1, wherein the computer readable program, when executed on the computer, causes the computer to display the graphical view as a graphical chart.

8. A system to display a graphical view for event drill-down, the system comprising:
an environment monitor to monitor an environment for an event, the environment monitor to generate and send a notification in response to detection of the event within the environment; and
a remote device to receive the notification, wherein the remote device is remote relative to at least one resource corresponding to the event, the remote device comprising:
a data storage device to store data;
a display device coupled to the data storage device, wherein the display device is configured to display the notification related to the event;
a user interface input device to facilitate a user input to generate a context menu corresponding to the notification, wherein the context menu comprises at least one user interaction option corresponding to the event; and
a processor coupled to the user interface input device and the display, wherein the processor is configured to generate the graphical view on the display of at least one relationship between the event and the at least one resource corresponding to the event, wherein the graphical view is available within the context menu.

9. The system of claim 8, wherein the processor is configured to generate the context menu in response to a user interaction at the notification.

10. The system of claim 8, wherein the processor is configured to generate the graphical view in response to a user interaction at the context menu.

11. The system of claim 8, wherein the processor is configured to execute a user-selected action as a response to the event, wherein the user-selected action is input at the user interface input device.

12. The system of claim 8, wherein the processor is configured to generate the graphical view and the at least one relationship on the display without executing a program external to a program of the context menu.

13. The system of claim 8, wherein the graphical view is a topographical view.

14. The system of claim 8, wherein the graphical view is a graphical chart.

15. A method for remote drill-down of an event, the method comprising:
generating a notification at an environment monitor, the notification corresponding to an event detected by the environment monitor at a resource of the environment;
receiving the notification at a device remote to the environment monitor;
receiving a first user input to generate a context menu, wherein the context menu comprises at least one user interaction option corresponding to the event; and
displaying a graphical view on a display of the device, the graphical view comprising at least one relationship between the event and the resource related to the event.

16. The method of claim 15, wherein the graphical view is displayed in response to a second user input at the context menu.

17. The method of claim 15, further comprising executing a user-selected action as a response to the event, wherein the user-selected action is input at the user interface input device.

18. The method of claim 15, wherein the graphical view is generated in an absence of executing an external program, wherein the external program is external to a program of the context menu.

19. The method of claim 15, wherein the graphical view is a topographical view.

20. The method of claim 15, wherein the graphical view is a graphical chart.
